(19) United States
(12) Patent Application Publication
(10) Pub. No.: US 2003/0175671 A1
(43) Pub. Date: Sep. 18, 2003

(54) Medical manifestations-diagnosis templates

(76) Inventor: Anuthep Benja-Athon, New York, NY (US)

Correspondence Address: ANUTHEP BENJA-ATHON M.D., Gr. Floor, 210 E 36TH STREET, NEW YORK, NY, 10016, US

(21) Appl. No.: 10/353,876

(22) Filed: Jan. 30, 2003

Related U.S. Application Data
(63) Continuation-in-part of application No. 09/191,795, filed on Nov. 13, 1998, now Pat. No. 6,132,218.

(51) Int. Cl. G09B 23/28

(52) U.S. Cl. 434/267

(57) ABSTRACT

A plurality of word templates each of which is a transcription of the electrochemical signals and codes in a network of brain neurons encompassing a medical diagnosis and pertinent clinical manifestations and review of systems. Each word template comprises a first word or term describing a medical diagnosis unites with a second group of words, terms and phrases representing the clinical manifestations and review of systems pertinent to the medical diagnosis. Each word template further comprises a words-terms architect which is a product of an hierarchy of relevance and importance of the words and terms in the second group of words, terms and phrases to the first word and term. Consequently, the present invention includes a method of forming and producing a plurality of word templates based on aforementioned phenomena and embodiments whereby a plurality of word templates are sort and ranked and whereby a first word, term, phrase and group of words and terms are used to garner pertinent second words, terms, phrases, groups and hierarchies of words, terms and phrases in the same word template and other word templates, and vice versa.

This is a continuation-in-part application of application Ser. No. 09/191,795 filed Nov. 11, 1998 now U.S. Pat. No. 6,132,218 granted to this applicant on Oct. 17, 2000 entitled Images for Communication of Medical Information in Computer.

### FIELD OF INVENTION

Templates of diagnoses and corresponding clinical manifestations and reviews of systems.

### BACKGROUND OF THE INVENTION

U.S. Pat. No. 6,132,218 entitled Images for Communication of Medical Information in Computer granted to this applicant on Oct. 17, 2000, and a pending patent, docket number ABA208, entitled the Best American Healthcare System filed Dec. 17, 2002, represent this applicant's continual quest to solve the current healthcare crisis and improve the American standard of living.

In the practice of medicine, the productions of documents from thoughts or impressions in the minds of physicians are tedious, repetitive tasks and time-consuming processes. From each thought or mental impression, a transcription of each medical diagnosis, clinical manifestations, review of systems and any combination thereof in a physician's mind associates involves a conversion or transcription of the electrochemical signals or codes in the network of neurons in the brain into a specific group of words and terms correspond to the electrochemical contents in said network of said thought or impression. However, in total, the permutations of the transcriptions comprise all diagnoses, clinical manifestations and reviews of systems are infinite permutations and productions of transcriptions. Therefore, the transcriptions necessarily involve the repetitive transfers and conversions of said thoughts or impressions of the diagnoses and pertinent clinical manifestations and review of systems into infinite amount of documents. Consequently, the reproduction processes are extremely or infinitely tedious and involve repetitive productions of groups of words, terms and phrases by about 690,000 physicians encountering billions of patient cases every year in America alone. The result is several billions repetitive and laborious transcriptions every year. Consequently, millions of hours of priceless physician time are wasted every year. This precious resources can be better used to serve humanity.

In an individual event in a doctor's brain and mind, each clinical impression leads to an extremely fast and random scans or “reaches for words” in the form of electrical and chemical signals and codes in a network of brain neurons to form individual “trains of thoughts”. These “trains of thoughts” further lead to the formation of corresponding and specific electrical and chemical signals, codes or patterns in the neurons and neural network of the brain. These encoded signals, codes or patterns in these neurons are perceived and related to as a word, term, phrase and a group of words, terms and phrases representing a medical diagnosis and a group of words, terms and phrases representing clinical manifestations and review of systems pertinent to said diagnosis. For billions of said events, said phenomena can be fairly organized, random, variable, inconsistent, incomplete or failures in the brains in different events and settings. Tediously and repetitively, the documents are the reflections, products and outcomes of said brain events—i.e. a universe of messes. Moreover, the brain tasks must be repetitively performed each and every time and all times.

The objective of the present invention is to eliminate the billions of repetitive, tedious and random tasks of transcribing or converting billions of medical thought processes into medical words and terms. The physicians' time, energy and concentration saved by the present invention will tremendously serve humanity.

### SUMMARY OF THE INVENTION

The transcriptions of medical documents from the electrochemical signals, codes and patterns in the brain network of neurons are tedious, repetitive and random processes.

The present invention is a plurality of word templates each of which is a complete set of transcription of the electrochemical signals and codes in a network of brain neurons encompassing a medical diagnosis and pertinent clinical manifestations and review of systems. Each word template comprises a first word and term describing a medical diagnosis which is united with a second group of words and terms representing the clinical manifestations and review of systems pertinent to the medical diagnosis. Each word template further a words-terms architect which is a product of an hierarchy of relevance and importance of said second group of words and terms to said first word and term. Furthermore, the present invention encompasses also a method of formations and productions of a plurality of word templates based on aforementioned phenomena and embodiments whereby a plurality of word templates are sort and ranked, a first word, terms, phrase and group of words and terms in each word template is used to garner pertinent second words, terms and phrases in the same word template and other word templates and vice versa, and a first word, terms, phrase and group of words and terms in each word template is used to garner a hierarchy of pertinent second words, terms and phrases in the same word template and other word templates, and vice versa.

### PREFERRED EMBODIMENTS OF THE INVENTION

The present invention is a plurality or a series of word transcriptions or word templates of terminology, terms and words representing medical diagnoses and pertinent clinical manifestations and reviews of systems. Each word transcription or word template comprises a medical diagnosis represents by a first word, term or first group of words and terms and a second group of words, terms representing pertinent and correlating clinical manifestations and review of systems. In other words, each word transcription or word template is a specific formula comprises words, terms and groups of words and terms representing a medical diagnosis and pertinent clinical manifestations and review of systems relavant to said medical diagnosis.

Each word template is a complete transcription of the brain electrochemical signals and codes in the network of neurons encoding a word, a term, a plurality of words, terms and phrases representing a medical diagnosis and a plurality of words, terms and phrases representing clinical manifestations and review of systems pertinent to said diagnosis. Moreover, each word template comprises a words-terms architecture, an order or hierarchy of words and terms as a function of the degrees of pertinence, relationship and significance of said second words, terms and group of words, terms and phrases to said first word, terms or first group of words and terms, and vice versa. Examples:

This physician applicant has the electrochemical signals and codes in the network of neurons encoding the words and terms on an infection by pork tapeworm in the next paragraph. This applicant chooses as a preferred embodiment of the present invention to transcribe said signals and codes into a triangular word template comprises said first word or term “Trichinosis” as a medical diagnosis and to form an approximately triangular words-terms architecture, an order or hierarchy of words and terms as a function of the degrees of pertinence, relationship and significance of second words, terms or group of words, terms and phrases—to said first word or term “Trichinosis”. The hierarchy of words, terms and phrases in the lines from top to bottom represents a decreasing pertinence, association, specificity and significance of clinical manifestations and review of systems to said first word or term “Trichinosis”:

Trichinosis

abdominal discomfort, diarrhea, fever muscle pain and tenderness, weakness, malaise periorbital edema, headache subungual, retinal and subconjunctival petechiae, hemorrhage, macular, petechial or urticarial rash

Further to same, another preferred embodiment is a linear word template on a hypothyroidism comprises: Hashimoto's Thyroiditis, weakness, fatigue, lethargy, dry and coarse skin, swelling of hands, face and limbs, cold intolerance, decreased sweating, weight gain, joint pain, constipation, muscle pain and cramps. This embodiment obeys the principle and concepts of the present invention.

Furthermore, the present invention encompasses also a method of formations and productions of a plurality of word templates based on aforementioned phenomena and embodiments whereby a plurality of word templates are sort and ranked.

The present invention also provides a method of using a first word, terms, phrase and group of words and terms in each word template to garner pertinent second words, terms and phrases in the same word template and other word templates and vice versa. For example, first word Trichinosis is used to garner a plurality of groups of words and terms such as, but not limited to, abdominal discomfort, muscle pain and fever. Moreover, said first word is used to garner an hierarchy of words and terms, such as, but not limited to:

abdominal discomfort, diarrhea, fever muscle pain and tenderness, weakness, malaise periorbital edema, headache subungual, retinal and subconjunctival petechiae, hemorrhage, macular, petechial or urticarial rash.

Further to same, said second group of words and terms such as, but not limited to, abdominal discomfort, muscle pain and fever can be used to garner said first word Trichinosis or other first word and term and other second words and terms, group of words and terms and other hierarchies of words and terms in the same template and other word templates.

Said first word or term Trichinosis can garner second words, terms, phrases and hierarchies of words, terms and phrases in the same word template and a plurality of word templates and vice versa. For example:

abdominal discomfort, diarrhea, fever muscle pain and tenderness, weakness, malaise periorbital edema, headache subungual, retinal and subconjunctival petechiae, hemorrhage, macular, petechial or urticarial rash and Hashimoto's thyroiditis, weakness, fatigue, lethargy, dry and coarse skin, swelling of face, hands and limbs, cold intolerance, decreased sweating, weight gain, joint pain, constipation, muscle pain and cramps.

For all intents and purposes, each of the above preferred embodiments represents a complete individual word template.

Having explained two preferred embodiments, the present invention provides a plurality of word templates as many as there are medical diagnoses and pertinent clinical manifestations and reviews of systems. Each word template is an exact, complete and accurate transcription of the electrical and chemical signals and codes in the brain neurons representing a medical diagnosis and all pertinent clinical manifestations and review of systems. In other words, a transcription or template comprises a plurality of terms or words representing a medical diagnosis and pertinent clinical manifestations and review of systems. As a result, each word template can be conveniently, expeditiously, accurately duplicated and reproducible and readily available by this physician applicant or any other physicians.

Although the preferred embodiments have been described, it will be appreciated by those skilled in the art and science of medicine that variations, additions and adaptations to the present invention can be had without departing from the spirit of the invention and the scope of the claims.

1. A means for transcribing brain electrochemical signals encoding words and terms and a plurality of words and terms representing medical diagnoses and a plurality of groups of words and terms representing clinical manifestations and reviews of systems pertinent to specific diagnoses adaptable, first, to reduce and eliminate the tedious and repetitive processes of transferring said signals into documents, second, to sort and rank said means for transcribing, and, third, to assist a physician to use a first word, term, phrase and group of words and terms to garner pertinent second words, terms and phrases and a hierarchy of said second words, terms and phrases wherein a said first word and term and group of words and terms representing a medical diagnosis unite with a said second group of words and terms representing pertinent said clinical manifestations and review of systems, wherein a wordsterms architect is a product of an hierarchy of relevance and importance of second group of words and terms to said first word and term and group of words and terms and wherein all unique words-terms architects and hierarchies are duplicated and reproducible comprises a plurality of word transcriptions.

2. The word transcription according to claim 1 is a word template comprises a word or a term representing a medical diagnosis.

3. The word transcription according to claim 1 is a word template comprises a plurality of words and terms representing a medical diagnosis.

4. The word transcription according to claim 1 is a word template comprises a group of medical diagnosis-related words pertinent to a word or a term representing a medical diagnosis.

5. The word transcription according to claim 1 is a word template comprises a group of words and terms representing clinical manifestations pertinent to a medical diagnosis.

6. The word transcription according to claim 1 is a word template comprises a group of words and terms representing review of systems pertinent to a medical diagnosis.

7. The word transcription according to claim 1 is a word template comprises a group of words and terms representing clinical manifestations and review of systems pertinent to a medical diagnosis.

8. The word template according to claim 2 comprises a word, term and words and terms describing a medical diagnosis and medical diagnosis-related words and terms pertinent to said word, term, words or terms representing a medical diagnosis.

9. The word template according to claim 2 comprises a group of words and terms representing clinical manifestations and review of systems pertinent to a word, term, words and terms representing a medical diagnosis.

10. The word template according to claim 2 comprises medical diagnosis-related words and terms align in an order and sequence as a function of a scale of relevance to a medical diagnosis.

11. The word template according to claim 2 comprises a group of words, terms and phrases representing clinical manifestations align in an order and sequence as a function of a scale of relevance to a medical diagnosis.

12. The word template according to claim 2 comprises a group of words, terms and phrases representing a review of systems align in an order and sequence as a function of a scale of relevance to a medical diagnosis.

13. The word template according to claim 2 comprises a hierarchy of words and terms representing clinical manifestations as a function of relevance and importance of said words and terms to a word, term, words and terms representing a medical diagnosis.

14. The word template according to claim 2 comprises a hierarchy of words and terms representing a review of systems as a function of relevance and importance of said words and terms to a word, term, words and terms representing a medical diagnosis.

15. The word template according to claim 2 comprises a hierarchy of words and terms representing clinical manifestations and a review of systems as a function of relevance of said words and terms to a word, term, words and terms representing a medical diagnosis.

16. The word template according to claim 2 comprises a hierarchy of words and terms representing clinical manifestations and a review of systems as a function of relevance and importance of said words and terms to a word, term, words and terms representing a medical diagnosis.

17. The word template according to claim 2 comprises a hierarchy of words and terms representing clinical manifestations and a review of systems as a function of the strength of association of said words and terms to a word, term, words and terms representing a medical diagnosis.

18. A method of transcribing human brain electrochemical signals in the network of brain neurons encoding a word and term representing a medical diagnosis and a group of words and terms representing pertinent clinical manifestations and review of systems into a word transcription is the formations and productions of:
a specific word template comprises a first word, term, and group of words and terms representing a medical diagnosis and a second group of words and terms representing clinical manifestations and review of systems pertinent to said first word, term and group wherein each word template further comprises a specific words-terms architecture and hierarchy of said words and terms as a function of relevance and strength of association of said second group of words and terms to said first word, term and group of words and terms;
a plurality of individual word templates each of which possesses said characteristics;
said method enables the sorting and ranking of word templates;
said method enables the use of a first word, terms, phrase and group of words and terms to garner pertinent second words, terms and phrases and vice versa; and
said method enables the use of a first word, terms, phrase and group of words and terms to garner a hierarchy of pertinent second words, terms and phrases, and vice versa.
